(19) United States
(12) Patent Application Publication
(10) Pub. No.: US 2003/0110718 A1
(43) Pub. Date: Jun. 19, 2003

(54) Marine window assembly

(76) Inventor: Daniel Boisvert, Freelton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/015,788

(22) Filed: Dec. 17, 2001

(51) Int. Cl. E06B 3/00

(52) U.S. Cl. 52/208; 52/510; 52/511

(57) ABSTRACT

A marine window assembly for installation within a boat cabin wall includes a piece of glazing material, a shielding member, first and second layers of sealant, and a plurality of fasteners. The first layer of sealant is disposed on a first face of the glazing material along a substantial portion of the circumferential perimeter and said second layer of sealant disposed on said second face of said glazing material. The shielding member is positioned over said second layer of sealant and said glazing material and fastening means are used to secure the shielding member, said glazing material and said first and second layers of sealant to said cabin wall against first and second substantially transverse surfaces of the opening. The first and second layers of sealant are chosen to have coefficients of thermal expansion that are substantially similar to that of the shielding member so that when the assembly is exposed to a range of temperatures, adhesion between first and second layers of sealant and shielding member will be maintained.

### FIELD OF THE INVENTION

This invention relates to window assemblies, and more particular to waterproof window assemblies for installation in a marine cabin wall.

### BACKGROUND OF THE INVENTION

Marine window assemblies must effectively seal the interior of a marine vessel from noise and weather elements of the external environment. For example, they must prevent various contaminants, such as moisture, dirt, and debris from getting into the interior of the boat. Window assemblies for installation within marine vessels must also endure well under extreme heat or cold conditions (i.e. seasonal changes) so that the sealing performance of the assembly is not substantially degraded over time.

In the manufacture of boats having windows, hatches, or windshields, one manufacturing technique is to glue a piece of transparent glass (or other glazing material) directly onto a boat so that an opening defined in a cabin body is closed by the piece of glass. However, there are a number of drawbacks associated with that procedure. Typically, during the course of wear and tear and temperature excursions, window assemblies do not maintain leak-proof seals due to the corrosive nature of environmental conditions in addition to temperature excursions. This is as a result of inadequate sealant adhesive and waterproof properties which result in degregation of the seal as the sealant is exposed to temperature extremes. In addition, the adhesive material undergoes ultraviolet degradation since in existing window assemblies, sunlight can pass directly through the glazing material to the adhesive material. This degradation can lead to bond failure.

Also, when repairing existing window installations, it is typically necessary to completely disassemble the assembly. Disassembly is destructive in nature and increases the difficulty and cost of repair substantially.

### SUMMARY OF THE INVENTION

The present invention provides a window assembly for installation within a boat cabin wall having an opening, the opening having first and second substantially transverse surfaces, said assembly comprising:

(a) a piece of transparent or translucent glazing material dimensioned to substantially close said opening and having a circumferential perimeter, and first and second opposite faces;

(b) a mounting structure for holding said glazing material in place substantially closing said opening, said mounting structure comprising:

(i) first and second layers of sealant, said first layer of sealant disposed on said first face of said glazing material along a substantial portion of the circumferential perimeter and said second layer of sealant disposed on said second face of said glazing material along a substantial portion of the circumferential perimeter;

(ii) a shielding member positioned over said second layer of sealant and said glazing material; and

(iii) fastening means for securing the shielding member, said glazing material and said first and second layers of sealant to said cabin wall against the first and second substantially transverse surfaces.

The present invention also provides a method of installing a piece of glazing material in an opening formed within boat cabin wall, said opening including first and second substantially transverse surfaces, using a window assembly comprising: a piece of transparent or translucent glazing material dimensioned to close the opening and having a circumferential perimeter and first and second opposite faces; first and second layers of sealant; a shielding member; and fastening means, said method comprising:

(a) applying the first layer of sealant to the first face of said glazing material along a substantial portion of the circumferential perimeter of said glazing material;

(b) placing the glazing material within said opening such that said first opposite face of said glazing material is positioned over said first and second substantially transverse surfaces;

(c) apply the second layer of sealant to the second face of said glazing material along a substantial portion of the circumferential perimeter of said glazing material;

(d) placing the shielding member over said second opposite face of said glazing material along a substantial portion of the circumferential perimeter of said glazing material; and

(e) securing the shielding member, said glazing material and said sealant to said cabin wall against said first and second substantially transverse surfaces using said fastening means to provide a substantially liquid leak-proof seal.

The present invention also provides a method of retrofitting a shielding assembly over a piece of glazing material having a circumferential perimeter and inner and outer opposite faces, in an opening formed within a cabin wall, said shielding assembly comprising: a shielding member; a layer of sealant and fastening means, said method comprising:

(a) applying the layer of sealant to the outer face of said glazing material along a substantial portion of the circumferential perimeter of said glazing material;

(b) placing the shielding member over said outer face of said glazing material along a substantial portion of the circumferential perimeter of said glazing material; and

(c) securing the shielding member, said glazing material and said sealant to said first and second layers of cabin wall using said fastening means to provide a substantially leak proof seal.

### BRIEF DESCRIPTION OF THE DRAWINGS

In the accompanying drawings:

FIG. 1A is an exploded side cross-sectional view of the marine window assembly of the present invention and an associated boat cabin wall opening;

FIG. 1B is a side cross-sectional view of the marine window assembly of FIG. 1A installed within the boat cabin wall opening of FIG. 1A;

FIG. 2 is a cross-sectional view of the shielding member of FIG. 1A;

FIG. 3 is a view of the marine window assembly of FIG. 1A installed within a boat cabin wall;

FIG. 4A is a side cross-sectional view of the boat cabin wall opening of FIG. 1A with a first layer of sealant disposed on the first and second substantially transverse surfaces of the opening;

FIG. 4B is a side cross-sectional view of the boat cabin wall opening of FIG. 1A with the glazing material positioned on top the first layer of sealant;

FIG. 4C is a side cross-sectional view of the boat cabin wall opening of FIG. 1A with a second layer of sealant disposed on the glazing material and the first layer of sealant over an edge of the boat cabin wall;

FIG. 4D is a side cross-sectional view of a completed installation of the marine window assembly of FIG. 1A where the shielding member positioned on top of another layer of sealant, the glazing material, and the first and second substantially transverse surfaces of the opening and securely fastened to the boat cabin wall to provide a substantially liquid leak-proof seal.

FIG. 5A is a side cross-sectional view of an existing window assembly installation with a second layer of corrosion inhibitive sealant 21 positioned thereabove; and

FIG. 5B is a side cross-sectional view of an existing window assembly installation showing the shielding member and the second layer of corrosive inhibitive sealant 21 applied to the top surface of the existing assembly in accordance with a retrofit application of the present invention.

### DETAILED DESCRIPTION OF THE INVENTION

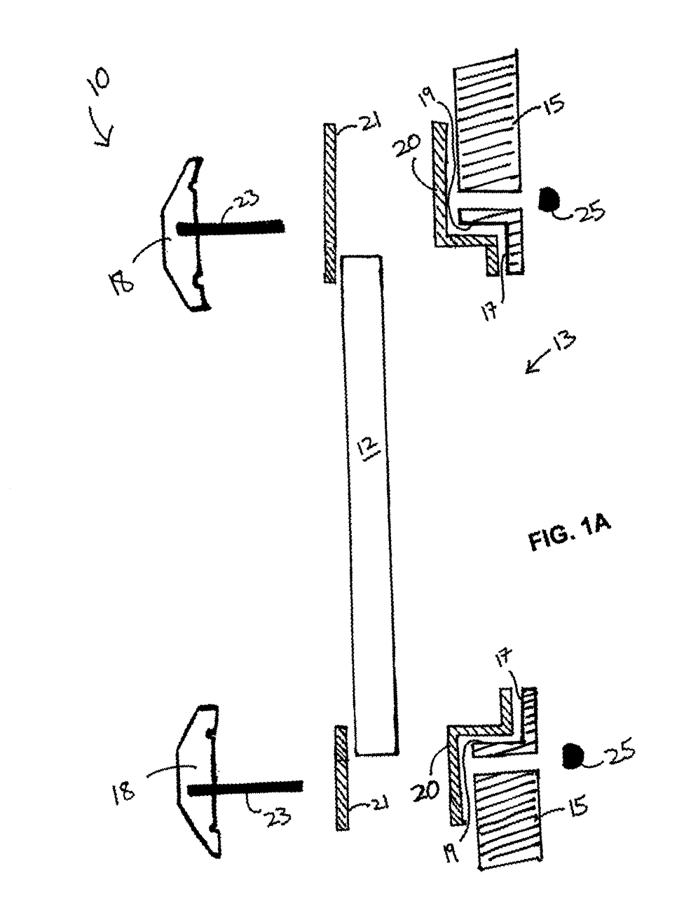

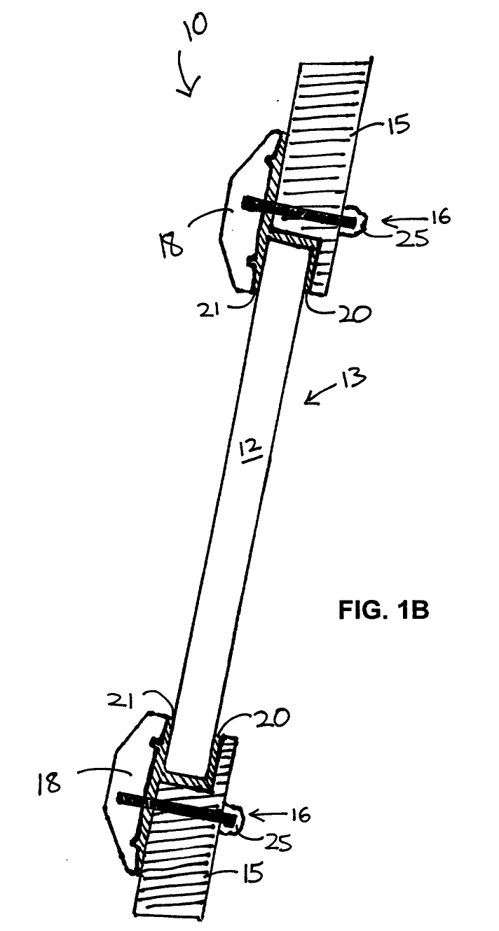

Referring to FIGS. 1A and 1B, illustrated therein is a marine window assembly 10 for installation within an opening 13 formed within a boat cabin wall 15, said marine window assembly 10 made in accordance with a preferred embodiment of the present invention. Marine window assembly 10 includes glazing material 12, a plurality of fasteners 16, a shielding member 18, and first and second layers of corrosion inhibitive sealant 20 and 21. Marine window assembly 10 is designed to be durable and when installed within opening 13 to prevent various contaminants, such as moisture, dirt, and debris from penetrating though assembly into the interior of the boat.

Glazing material 12 (of any conventional type, such as glass, tempered glass, acrylic, polycarbonate, etc., flat or curved) is sized to fit within opening 13 within boat cabin wall 15 as is conventionally known. Boat cabin wall 15 may be any conventional cabin wall in which a glued in window, hatch, or windshield system is typically provided. Boat cabin wall 15 may be made of any suitable material, such as fiberglass, aluminum, wood, molded plastic, or the like, fiberglass being the most common material. Boat cabin wall 15 defines one or more openings 13 for a window, hatch, and/or a windshield. Each opening 13 (see FIG. 1) including first and second transverse surfaces 17 and 19 against which glazing material 12 is to be mounted.

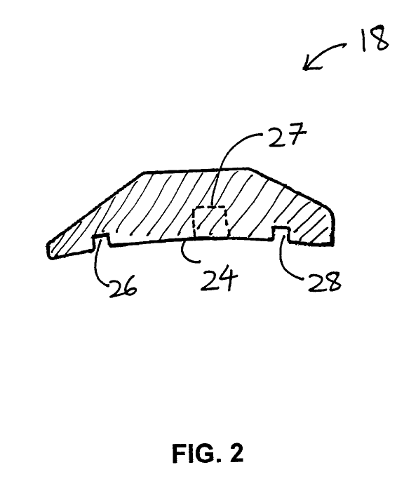

Referring to FIGS. 1A, 1B and 2, shielding member 18 is utilized to secure glazing material 12 to boat cabin wall 15 as well as to shield sealant 20 from the elements so that an enduring leak-resistant seal is produced between glazing material 12 and boat cabin wall 15. As shown, shielding member 18 prevents sunlight and ultraviolet radiation from penetrating and degradating first and second layers of corrosion inhibitive sealant 20 and 21. Accordingly, the use of shielding member 18 prevents this type of degredation of the window seal.

FIG. 2 is a sectional view of shielding member 18 that illustrates its structure. Shielding member 18 is a longitudinal member having a curved bottom surface 24 and a pair of longitudinal grooves 26 and 28. The curved bottom surface 24 allows for a substantial volume of the second layer of sealant 21 to be positioned along the longitudinal axis of shielding member 18. This, in combination with the presence of the pair of longitudinal grooves 26 and 28 within the bottom surface 24 allows said second layer of sealant 21 to contact a larger amount of surface area of shielding member 18 and glazing material 12 forming a secure leak-proof seal. Shielding member 18 is preferably made of aluminum, or a similar durable and corrosion inhibiting material. Also, shielding member 18 contains (shown in dotted outline) a plurality of fastener cavity 27, within which fastening means 16 (e.g. a bolt 23 of FIG. 1A) may be installed.

Referring back to FIGS. 1A and 1B, shielding member 18 is dimensioned to cover a portion of the outer edge of glazing material 12 over second layer of sealant 21 as well as to extend over a part of the outer edge of boat cabin wall 15 so that shielding member 18 can securely hold glazing material 12 in place and so that first and second layers of sealant 20 and 21 are shielded from potentially corrosive elements. It should be understood that shielding member 18 can be provided in sections, each having various shapes, so that various shaped pieces of glazing material 12 can be accommodated within marine window assembly 10. For example, it would be possible to provide a series of sections of shielding member 18,each having sufficient curvature so that a complete circle can be made out of the sections.

Fasteners 16 are used to firmly secure shielding member 18 to boat cabin wall 15 so that glazing member 12 is not displaced and remains firmly in place. It should be understood that fastener 16 is preferably implemented using a bolt 23 and nut 25 assembly as shown in FIGS. 1A and 1B, where bolt 23 is fixed within sealing member 18 (i.e. within fastener cavity 27) and nut 25 is used to anchor shielding member 18 and glazing material 12 against transverse surfaces 17 and 19. It should be understood that fastener 16 could also be implemented by a large variety of fastening means, including bolts, adhesives, or other rigid securing means.

First and second layer of sealant 20 and 21 are placed in all the crevices and openings between boat member 13, shielding member 10, and glazing material 12 as shown in FIGS. 1A and 1B. First and second layers of sealant 20 is preferably corrosion inhibitive such as the P/S 870 Class B selant manufactured by PRC-DeSoto International, Inc. This type of sealant has a service temperature range from −65° F. (−54° C.) to 250° F. (121° C.), with intermittent excursions up to 275° F. (135° C.). First and second layers of sealant 20 and 21 material also acts as an effective barrier against the common causes of corrosion on aluminum alloys or between dissimilar metals. Also, sealant 20 prevents contaminants from penetrating boat window sealing assembly 16 by curing at room temperature to form a resilient sealant.

According to the present invention, first and second layers of sealant 20 and 21 must have good adhesion properties in respect of the materials used for shielding member 18 and glazing member 12. Also, according to the present invention, the coefficient of thermal expansion (CTE) of first and second layers of sealant 20 and 21 should be substantially similar to the coefficient of thermal expansion (CTE) of the shielding member 18, so that when marine window assembly 10 is exposed to a wide range of temperature extremes, the expansion/contraction of first and second layers of sealant 20 and 21 will not be substantially different than that of shielding member 18. Accordingly, adhesion between first and second layers of sealant 20 and 21 and shielding member 18 will be maintained even under harsh weather conditions. It should be understood that other types of commercially available sealant having similar corrosion inhibitive and coefficients of thermal expansion (CTE) that are substantially similar to those of shielding member 18 and glazing material 12 may be utilized within the invention as well.

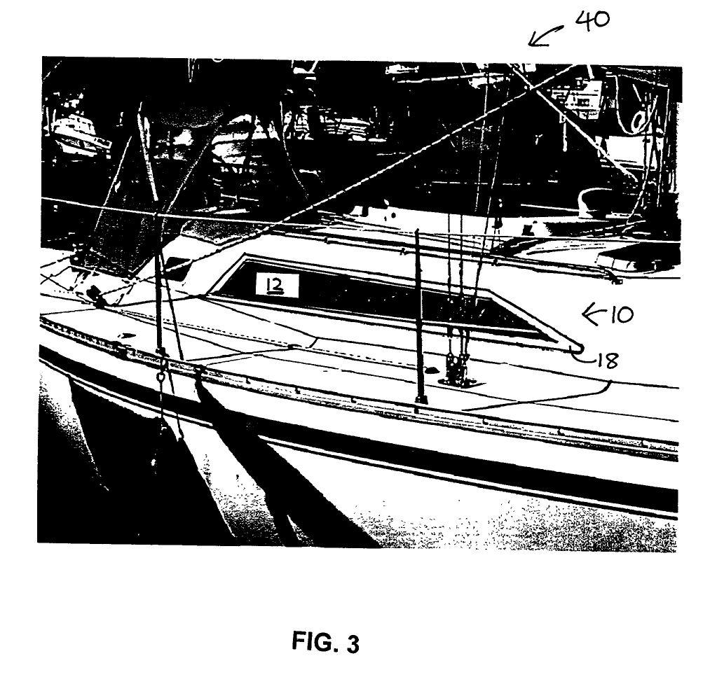

Referring now to FIG. 3, marine window assembly 10 is shown in use on a boat 40. Marine window assembly 10 endures well under extreme heat and cold conditions, unlike traditional window assemblies. Since first and second layers of sealant 20 and 21 are chosen to correspond to the thermal expansion characteristics of the shielding member 18 and glazing material 12, the assembly 10 is a robust system throughout extremes of temperature. Also, the marine window assembly 10 of the present invention allows for a relatively simpler, faster and less dangerous installation of a window within a marine cabin wall than other traditional window assemblies.

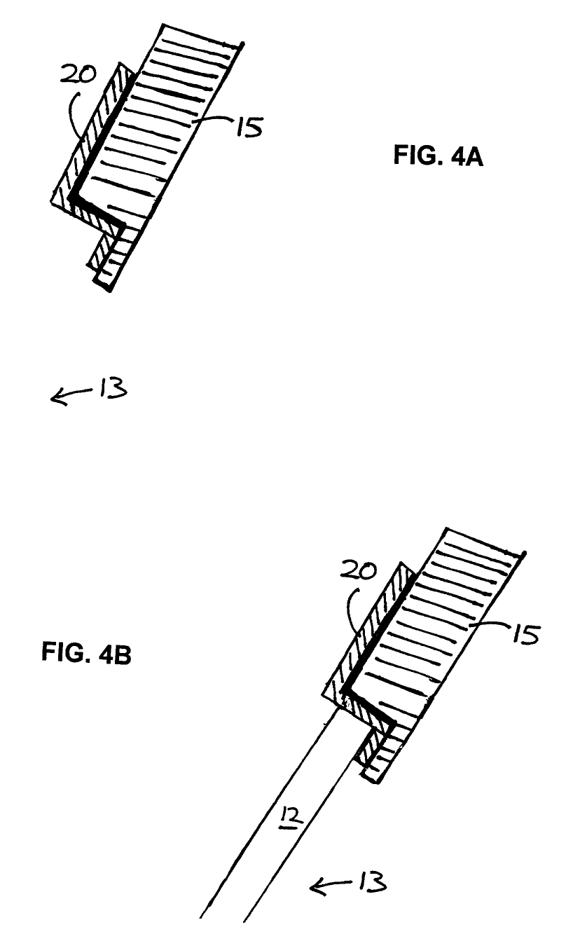

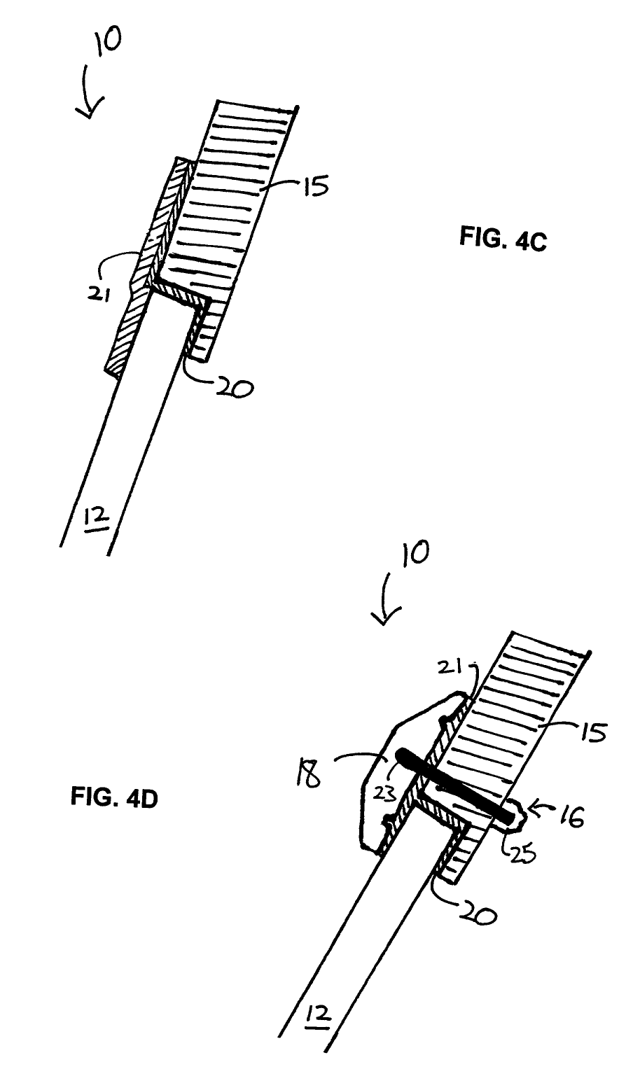

Referring now to FIGS. 4A, 4B, 4C, and 4D, a method of installing glazing material 12 within boat cabin wall 15 according to the present invention is illustrated by reference to a cross-sectional view of an edge of marine window assembly 10 as it appears during the course of installation within opening 13 of boat cabin wall 15.

FIG. 4A shows how first layer of sealant 20 is applied to the outer edge of boat cabin wall 15 as well as to first and second transverse surfaces 17 and 19. First layer of sealant 20 is disposed on edge of boat cabin wall 15 and to first and second transverse surfaces 17 and 19 along the circumferential perimeter of opening 13. Prior to applying first layer of sealant 20 to edge of cabin wall 15 and transverse surfaces 17 and 19, these surfaces are prepared using solvents to remove dirt, grease and processing lubricants. First layer of sealant 20 is then cured at room temperature for a suitable period of time (e.g. 4 hours or at whatever temperature and setting conditions are necessary for sealant to properly cure according to manufacturer's specifications) to form a resilient sealant having good adhesion properties to glazing material 12 and shielding member 18.

FIG. 4B illustrates how once first layer of sealant 20 is cured, glazing material 12 is placed within cabin wall 15 such that the inner edge of glazing material 12 contacts first layer of sealant 20 on both transverse surfaces 17 and 19 and abuts against boat cabin wall 15 therein. Glazing material 12 is pressed into place against first layer of sealant 20 so that a leak-proof seal is formed.

FIG. 4C illustrates how second layer of sealant 21 is then applied to the top edge of glazing material 12 along the circumferential perimeter. Second layer of sealant 21 is then cured at room temperature for a suitable period of time (e.g. 4 hours or at whatever temperature and setting conditions are necessary for sealant to properly cure according to manufacturer's specifications) to form a resilient sealant with adhesion properties to glazing material 12 and shielding member 18.

FIG. 4D shows how finally, shielding member 18 is positioned over second sealant layer 21 and secured in place using a plurality of fasteners 16 (only one shown in FIG. 4D). Each fastener 16 is comprised of a bolt 23 and a nut 25 as shown. As shown in FIGS. 4A, 4B and 4C, boat cabin wall 15 does not necessarily need to be provided with fastener cavity 27 (FIG. 2). Rather, openings can be provided within assembly 10 prior to the insertion of fasteners 16 (e.g. using a drill). As fasteners 16 are tightened to secure shielding member 18 over first and second layer of sealant 20 and 21 and glazing material 12, excess sealant may be pressed out of assembly 10 and can be removed using appropriate tools (e.g. putty knife, etc.)

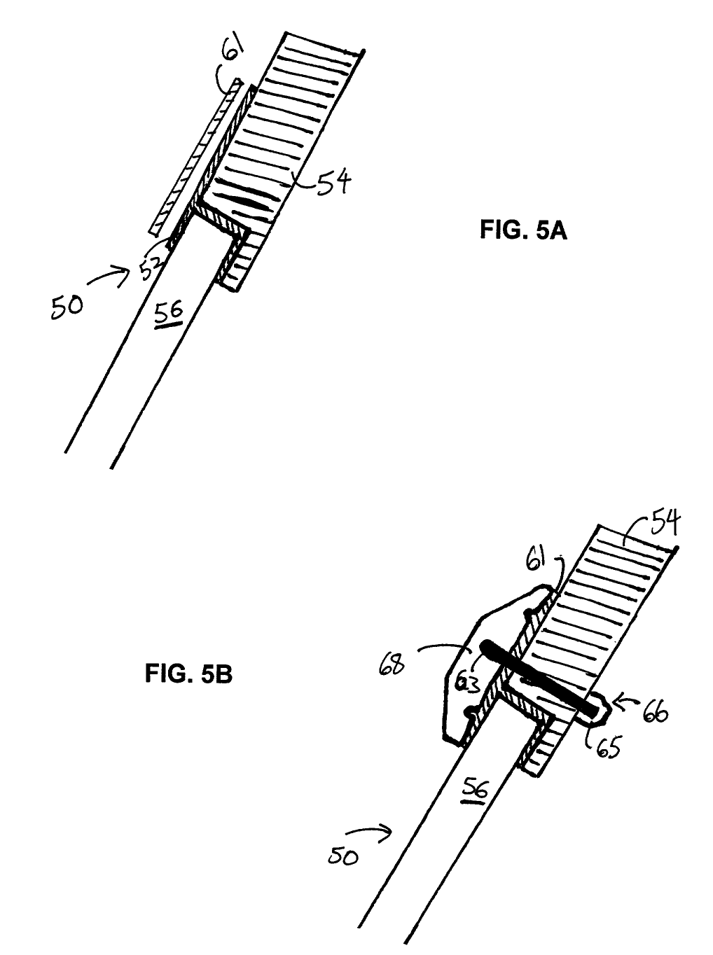

Finally, as shown in FIGS. 5A and 5B, an existing window assembly 50 can be retrofitted using a shielding member 68 having the same physical structure and design of shielding member 18 (FIG. 2).

FIG. 5A shows an existing window assembly 50, where an existing layer of glue 52 has been used to secure glazing material 56 into an opening in a boat cabin wall 54. As shown, and according to the invention, a layer of sealant 61 is applied to the outer surface of existing window assembly 50. Sealant 61 is allowed to cure at room temperature for a suitable period of time to form a resilient sealant. Sealant 61 will bond to the existing glue 52.

FIG. 5B shows how shielding member 68 is positioned over sealant layer 61 and secured in place using a plurality of fasteners 66 (only one is shown in FIG. 5B). As discussed in respect of FIG. 5B, holes can be provided through boat cabin wall prior to fastening with fasteners 66. Pressure applied by tightening fasteners 66 will ensure that a secure leak-resistant seal is produced between glazing material 56 and boat cabin 54.

Accordingly, FIGS. 5A and 5B illustrate how an existing window assembly can be retrofitted with a shielding member 68 so as to improve the quality and endurance of the seal between glazing material 56 and boat cabin wall 54. This approach does not require any destructive disassembly, but instead provides increased sealing integrity to an existing installation in a convenient manner.

Only one embodiment of marine window assembly 10 of the present invention has been described. As will be apparent to those skilled in the art, various modifications and adaptations of the structure described above are possible without departing from the present invention, the scope of which is defined in the appended claims.

1. A window assembly for installation within a boat cabin wall having an opening, the opening having first and second substantially transverse surfaces, said assembly comprising:
(a) a piece of transparent or translucent glazing material dimensioned to substantially close said opening and having a circumferential perimeter, and first and second opposite faces;
(b) a mounting structure for holding said glazing material in place substantially closing said opening, said mounting structure comprising:
(i) first and second layers of sealant, said first layer of sealant disposed on said first face of said glazing material along a substantial portion of the circumferential perimeter and said second layer of sealant disposed on said second face of said glazing material along a substantial portion of the circumferential perimeter;
(ii) a shielding member positioned over said second layer of sealant and said glazing material; and
(iii) fastening means for securing the shielding member, said glazing material and said first and second layers of sealant to said cabin wall against the first and second substantially transverse surfaces.

2. The assembly of claim 1, wherein said shielding member has a curved and grooved bottom surface.

3. The assembly of claim 2, wherein said curved bottom of said shielding member is adapted to provide additional space for said first and second layer of sealant along the longitudinal axis of said shielding member.

4. The assembly of claim 1, wherein said first and second layer of sealant have a coefficient of thermal expansion that is substantially similar to the coefficient of thermal expansion of the shielding member.

5. The assembly of claim 1, wherein said first and second layers of sealant is corrosion inhibitive.

6. The assembly of claim 1, wherein said fastening means comprises a plurality of longitudinally spaced nut and bolt assemblies extending between said shielding member and said cabin wall for securely biasing the shielding member to the cabin wall.

7. A method of installing a piece of glazing material in an opening formed within boat cabin wall, said opening including first and second substantially transverse surfaces, using a window assembly comprising: a piece of transparent or translucent glazing material dimensioned to close the opening and having a circumferential perimeter and first and second opposite faces; first and second layers of sealant; a shielding member; and fastening means, said method comprising:
(a) applying the first layer of sealant to the first face of said glazing material along a substantial portion of the circumferential perimeter of said glazing material;
(b) placing the glazing material within said opening such that said first opposite face of said glazing material is positioned over said first and second substantially transverse surfaces;
(c) applying the second layer of sealant to the second face of said glazing material along a substantial portion of the circumferential perimeter of said glazing material;
(d) placing the shielding member over said second face of said glazing material along a substantial portion of the circumferential perimeter of said glazing material; and
(e) securing the shielding member, said glazing material and said first and second layers of sealant to said cabin wall against said first and second substantially transverse surfaces using said fastening means to provide a substantially liquid leak-proof seal.

8. The method of claim 7, wherein step (a) comprises applying the first layer of sealant to the first opposite face of said glazing material along the whole of the circumferential perimeter of said glazing material.

9. The method of claim 7, wherein step (c) comprises applying the second layer of sealant to the first opposite face of said glazing material along the whole of the circumferential perimeter of said glazing material.

10. The method of claim 7, wherein step (d) comprises placing the shielding member over said second opposite face of said glazing material along the whole of the circumferential perimeter of said glazing material.

11. The method of claim 7, further comprising the step of allowing the first layer of sealant to cure after step (a) and allowing the second layer of sealant to cure after step (c).

12. A method of retrofitting a shielding assembly over a piece of glazing material having a circumferential perimeter and inner and outer opposite faces, in an opening formed within a cabin wall, said shielding assembly comprising: a shielding member; a layer of sealant and fastening means, said method comprising:
(a) applying the layer of sealant to the outer face of said glazing material along a substantial portion of the circumferential perimeter of said glazing material;
(b) placing the shielding member over said outer face of said glazing material along a substantial portion of the circumferential perimeter of said glazing material; and
(c) securing the shielding member, said glazing material and said sealant to said first and second layers of cabin wall using said fastening means to provide a substantially leak proof seal.

13. The method of claim 12, wherein step (a) comprises applying the layer of sealant to the outer face of said glazing material along the whole of the circumferential perimeter of said glazing material.

14. The method of claim 12, wherein step (b) comprises placing the shielding member over said outer face of said glazing material along the whole circumferential perimeter of said glazing material.

15. The method of claim 12, further comprising the step of allowing the layer of sealant to cure after step (a).
